(19) United States
(12) Patent Application Publication
(10) Pub. No.: US 2022/0004910 A1
(43) Pub. Date: Jan. 6, 2022

(54) INFORMATION PROCESSING METHOD, ELECTRONIC DEVICE, AND COMPUTER STORAGE MEDIUM

(71) Applicant: NEC CORPORATION, Tokyo (JP)

(72) Inventors: Wenjuan Wei, Beijing (CN); Lu Feng, Beijing (CN)

(73) Assignee: NEC CORPORATION, Tokyo (JP)

(21) Appl. No.: 17/363,525

(22) Filed: Jun. 30, 2021

(30) Foreign Application Priority Data
Jul. 1, 2020 (CN) 202010627708.5

(51) Int. Cl. G06N 7/00

(52) U.S. Cl. CPC G06N 7/005

(57) ABSTRACT

Implementations of the present disclosure relate to information processing method, electronic device, and computer storage medium. The method comprises: obtaining a group of variables; obtaining a causal model; using the causal model to determine causality among variables in the group of variables based on types of the variables in the group of variables. Using the technical solution of the present disclosure, a mixture of complex, non-linear continuous data or discrete data may be processed using a new model, and thus causality among observed data may be determined.

### FIELD

Exemplary implementations of the present disclosure relate to the technical field of determining causality, and more specifically, to information processing method, electronic device, and computer storage medium.

### BACKGROUND

Causal discovery is recognized as a challenging but powerful data analysis tool. Such a method supports revealing of a causal structure under a complex system, thereby providing a clear description of a potential generating mechanism. Although interventions or random experiments provide excellent standards for causality discovery, such methods are not feasible in many cases. Alternatively, causality may be recovered from passive observed data, which has become possible under appropriate conditions.

Discovering causality from observed data is a fundamental problem. Many methods have been proposed for this purpose over the years. However, these methods usually can only process a single type of data, i.e., only continuous variables or only discrete variables. Recently some causal structure discovery methods have been developed for mixed data types, and they have brought a wider range of applications. However, most of them only identify the Markov equivalence class of a graph, so undirected edges will be left in the resulting causality graph. Therefore, it is impossible to accurately and effectively determine the causality.

### SUMMARY

Exemplary implementations of the present disclosure provide a technical solution for information processing.

In a first aspect of the present disclosure, an information processing method is provided. The method comprises: obtaining a group of variables; obtaining a causal model; using the causal model to determine causality among variables in the group of variables based on types of the variables in the group of variables.

In a second aspect of the present disclosure, an information processing device is provided. The device comprises: at least one processing unit; at least one memory, coupled to the at least one processing unit and storing instructions executed by the at least one processing unit, the instructions, when executed by the at least one processing unit, causing the device to perform acts, including: obtaining a group of variables; obtaining a causal model; using the causal model to determine causality among variables in the group of variables based on types of the variables in the group of variables.

In a third aspect of the present disclosure, a computer-readable storage medium is provided. The computer-readable storage medium comprises computer-readable program instructions stored thereon, the computer-readable program instructions being used to perform a method according to the first aspect of the present disclosure.

This Summary is provided to introduce a selection of concepts in a simplified form that are further described below in the Detailed Description. This Summary is not intended to identify key features or essential features of the present disclosure, nor is it intended to be used to limit the scope of the present disclosure.

### BRIEF DESCRIPTION OF THE DRAWINGS

Through the more detailed description of exemplary implementations of the present disclosure with reference to the accompanying drawings, the above and other objects, features and advantages of the present disclosure will become more apparent, wherein the same reference numerals typically represent the same components in the exemplary implementations of the present disclosure.

FIG. 1 shows a schematic view of an information processing environment 100 in which an information processing method according to some exemplary implementations of the present disclosure may be implemented;

FIG. 2 shows a flowchart of an information processing method 200 according to exemplary implementations of the present disclosure;

FIG. 3 shows a schematic view of an information processing procedure 300 according to exemplary implementations of the present disclosure;

FIG. 4 shows a schematic view of a causality graph 400 according to exemplary implementations of the present disclosure;

FIG. 5 shows a block diagram of an information processing apparatus 500 according to exemplary implementations of the present disclosure; and

FIG. 6 shows a schematic view of an example device 600 which is applicable to implement exemplary implementations of the present disclosure.

Throughout the figures, the same or corresponding numerals denote the same or corresponding parts.

### DETAILED DESCRIPTION OF IMPLEMENTATIONS

Some preferable implementations will be described in more detail with reference to the accompanying drawings, in which the preferable implementations of the present disclosure have been illustrated. However, the present disclosure can be implemented in various manners, and thus should not be construed to be limited to implementations disclosed herein. On the contrary, those implementations are provided for the thorough and complete understanding of the present disclosure, and completely conveying the scope of the present disclosure to those skilled in the art.

The terms “comprise” and its variants used here are to be read as open terms that mean “include, but is not limited to.” Unless otherwise specified, the term “or” is to be read as “and/or.” The term “based on” is to be read as “based at least in part on”. The terms “one exemplary implementation” and “one implementation” are to be read as “at least one implementation.” The term “another implementation” is to be read as “at least one other implementation.” The terms “first,” “second” and the like may refer to different or the same objects. Other definitions, explicit and implicit, might be included below.

As mentioned in the BACKGROUND, it is impossible to accurately and effectively determine causality from observed data by using traditional methods for causality determining.

Specifically, with traditional methods for causality determining, by setting Markov conditions and loyalty, a method based on conditional independence may identify the causal skeleton from the joint distribution, for example, through a computer usage statistical test (conditional independent test), and direct edges to Markov equivalence classes through a series of rules (e.g., identifying v-shaped structures or colliders, avoiding loops, etc.). On the contrary, the causal mechanism and data distribution are described through a specific model category (an identifiable functional model or structural equation model (SEM)). If the data generating process belongs to such a model category, a complete causal diagram may be identified.

However, most of these methods rely on restrictive conditions about a single data type, i.e., continuous data type or discrete data type. Recent research has focused on relaxing such conditions about data types and recovering causal structures from mixed data. For this reason, constraint-based methods and score-based methods have been proposed. However, most of them directly use conditional independence tests or characteristics based on the (conditional) independence relationship between variables to introduce a scoring function, so as to only identify Markov equivalence classes of the graph, leaving some undirected edges. Only one method may identify a directed acyclic graph (DAG) that encodes a causal structure, but this method is only used for linear causal mechanisms, which limits its applicability.

In order to at least partly solve one or more of the above and other potential problems, implementations of the present disclosure propose a model for using mixed data types of data to determine causality among variables. The model may take variables and their set of parent variables as input, determine the causal order between variables and optionally determine an association, and further determine the causal relationship between variables, and then output the determined causality in the form of a directed acyclic graph.

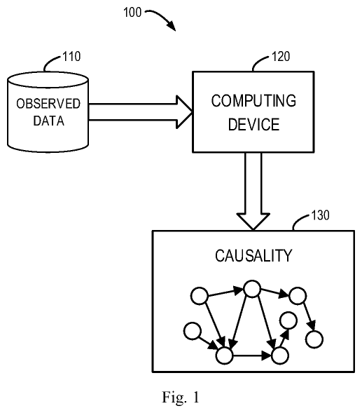

FIG. 1 shows a schematic view of an information processing environment 100 in which an information processing method according to some exemplary implementations of the present disclosure can be implemented. As depicted, the information processing environment 100 comprises observed data 110 as input data of a computing device 120, the computing device 120 and causality 130 as output data of the computing device 120. It is noteworthy that the information processing environment 100 is extensible, which may comprise more observed data 110 as input data, more causality 130 as output data, and more computing devices 120 to support parallel computing for the observed data 110. For the purpose of simplifying the schematic view, only one observed data 110, one computing device 120 and one piece of causality 130 are shown in FIG. 1.

In the information processing environment 100, the computing device 120 may establish and use a functional model for mixed types of variables to determine the causality 130 through the observed data 110. Specifically, the model allows the causal mechanism to become non-linear, thereby supporting a wider range of practical applications.

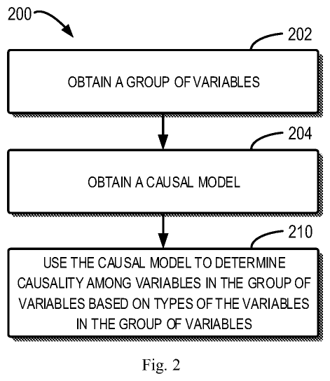

FIG. 2 shows a flowchart of an information processing method 200 according to exemplary implementations of the present disclosure. Specifically, the method 200 may be implemented by the computing device 120. It should be understood that the method 200 may further comprise an additional operation which is not shown and/or may omit an operation which is shown, and the scope of the present disclosure is not limited in this regard.

At block 202, the computing device 120 obtains a group of variables. According to exemplary implementations of the present disclosure, the group of variables obtained by the computing device 120 at block 202 is the observed data 110, the observed data 110 comprising at least one of continuous data and discrete data, the continuous data and the discrete data corresponding to a continuous variable type and a discrete variable type respectively. Continuous data means that there are numerous values of the data, and discrete data means that there are only a finite number of values of the data. For example, the height of a person is continuous data: there are 1.75 meters between 1.7 meters and 1.8 meters, 1.72 meters between 1.7 meters and 1.75 meters, 1.705 meters between 1.7 meters and 1.71 meters, and so on and so forth. Thus, there are an infinite number of values. However, the number of transportation types which people can choose to go to work is limited. They either choose buses, subways, bicycles, private cars or trains, etc. Thus, this is discrete data. An individual's choice of residence and occupation is also discrete data because the number of candidates is also limited.

According to exemplary implementations of the present disclosure, continuous variables and discrete variables may be associated with, for example, an application system for machining and correspond to multiple attributes of the application system. For example, different variables may represent the quality level, part size and smoothness in the polishing stage, the raw material of a part, and whether the product is qualified.

At block 204, the computing device 120 obtains a causal model. According to exemplary implementations of the present disclosure, the group of variables obtained at block 202 and information related to the group of variables, e.g., type of variables, other subset of variables and the number of variables, may be used as input of the causal model. According to exemplary implementations of the present disclosure, the causal model obtained at block 204 is a mixed non-linear causal model, wherein linearity means that uniformity and superposition need to be satisfied, the uniformity means that if y and x are in a linear relationship, then ay and ax are also in a linear relationship (a is any positive number), and the superposition means that if y1 and x1 are in a linear relationship and y2 and x2 are in a linear relationship, then y1+y2 and x1+x2 are also in a linear relationship respectively. Other relationships than the linear relationship are non-linear relationships. More generally, the combination of uniformity and superposition is referred to as linearity. According to exemplary implementations of the present disclosure, the causal model obtained at block 204 may determine, from the group of variables and information related to the group of variables obtained at block 202, possible causality among these variables, take a further operation to screen the determined causality and finally obtain accurate causality.

At block 206, the computing device 120 uses the causal model obtained at block 204 to determine causality among variables in the group of variables based on types of variables in the group of variables. According to exemplary implementations of the present disclosure, the causal model obtained at block 204 may perform different operations with respect to different types of variables, thereby outputting causality among these variables where the model input comprises different types of variables.

According to exemplary implementations of the present disclosure, with respect to each variable in the group of variables obtained at block 202, the computing device 120 may determine a set of parent variables of the variable and determine the causality among variables based on the type of the variable and the set of parent variables of the variable. According to exemplary implementations of the present disclosure, the set of parent variables of a variable is a set of variables on which a value of the variable relies, i.e., the variable has causality with a variable in the set of parent variables of the variable. For example, in the machining application system, the quality level, part size and smoothness in the polishing stage may be reasons for determining whether the product is qualified. Thus, these variables have causality, and the variables, i.e., the quality level, part size and smoothness in the polishing stage, may constitute a set of parent variables of the variable, i.e., whether the product is qualified.

According to exemplary implementations of the present disclosure, the computing device 120 may use the causal model obtained at block 204 to determine a causal sequence between variables in the group of variables obtained at block 202, and determine the causality based on the determined causal sequence. According to one implementation of the present disclosure, only when there is a causal sequence between two variables, the two variables might have causality. Therefore, the computing device 120 may use the causal model obtained at block 204 to determine the possible causal sequence between variables by a method like greedy search.

According to some exemplary implementations of the present disclosure, the computing device 120 may first use the causal model obtained at block 204 to obtain an initial causal sequence between variables in the group of variables obtained at block 202. Then, the computing device 120 may determine fitness of the initial causal sequence, wherein the fitness indicates a probability that the initial causal sequence correctly represents the causal sequence between variables. Finally, the computing device 120 may determine the causal sequence between variables based on the fitness and the initial causal sequence.

According to still some exemplary implementations of the present disclosure, the computing device 120 may first generate a parent relationship graph of each variable in the group of variables based on the determined set of parent variables of each variable for variables in the group of variables obtained at block 202. Then, the computing device 120 may determine the causal sequence between variables by using, for example, a graph theory method based on the parent relationship graphs.

According to exemplary implementations of the present disclosure, when the association between two variables is relatively low, even if it is considered that the two variables have a causal sequence, it is possible that no causality between the two variables can be determined. Therefore, the computing device 120 may use the causal model obtained at block 204 to further determine association between variables by a method such as greedy search, and determine the causality based on the determined causal sequence and association.

According to further exemplary implementations of the present disclosure, the computing device 120 may first use the causal model obtained at block 204 to determine initial causality among variables in the group of variables obtained at block 202 based on the determined causal sequence between variables. Then, the computing device 120 may conduct a conditional independence test on the initial causality. Finally, the computing device 120 may determine the causality among variables based on a result of the conditional independence test and the initial causality. Additionally, in this operation the computing device 120 may also first determine association between variables, and determine the initial causality based on the determined causal sequence between variables and the determined association between variables. Since both the causal sequence and the association are used, the initial causality determined at this point will become more accurate.

According to some exemplary implementations of the present disclosure, the computing device 120 may first obtain causal information about the group of variables, the causal information indicating partial causality among a part of variables in the group of variables and comprising expert knowledge integration. Then, the computing device 120 may use the causal model obtained at block 204 to determine the causality among variables in the group of variables based on the determined causal sequence between variables and the causal information. It should be understood that the causal information is related to the group of variables as the observed data 110 and thus may be obtained in the operation shown at any of blocks 202, 204 and 206. Additionally, in the operation, the computing device 120 may also first determine association between variables, and determine the causality among variables in the group of variables based on the determined causal sequence, association and causal information between variables, thereby determining the causality more accurately.

According to further exemplary implementations of the present disclosure, the computing device 120 may determine the causality by at least one of a constraint-based solution and a search-based solution. Typical constraint-based technical solutions mainly comprise a PC (Peter-Clark) algorithm and an inductive causation algorithm, etc., which may comprise an undirected graph learning stage and a direction learning stage. Search-based solutions comprise, for example, a greedy equivalence search (GES) solution.

According to some exemplary implementations of the present disclosure, the determined causality among variables in the group of variables may take the form of a directed acyclic graph, the directed acyclic graph comprising nodes and edges, a node representing a variable in the group of variables, and an edge representing causality among variables.

According to some exemplary implementations of the present disclosure, the performance of the application system may be improved based on the causality determined at block 206. Specifically, causal variables affecting the causality in the application system may be adjusted or monitored, so that the performance of the application system may be improved. In addition, it is also possible to promote the performance improvement of the application system by automatically the causality as an analysis result where a predetermined condition is met. For example, regarding a power transmission system, if causality among the intermediate voltage at each transmission device, the working state of the transmission system, current and power loss has been determined, then the variable that most affects the power loss may be adjusted first based on the found causality. In this way, the performance of the power transmission system may be improved.

According to further exemplary implementations of the present disclosure, the running of the application system may be adjusted based on the causality determined at block 206, for example, the application system may be debugged based on the causality. For example, regarding the machining system, if the causality among various attributes and the fact whether the product is qualified has been determined, then the attribute that most affects unqualified products may be adjusted first based on the found causality.

According to some exemplary implementations of the present disclosure, the computing device 120 may transmit the causality determined at block 206. For example, the computing device 120 may transmit the causality to one or more of the above application systems, and adjust the causal variable in the causality of the application system based on the causality, e.g., adjusting the observed data.

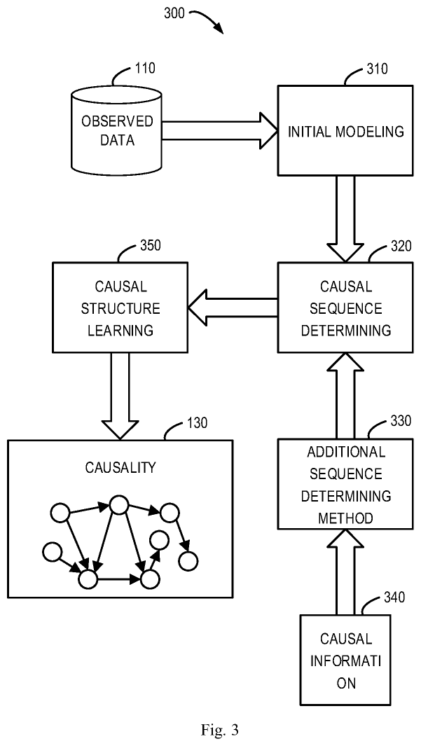

FIG. 3 shows a schematic view of an information processing process 300 according to exemplary implementations of the present disclosure.

Through the information processing process 300, implementations of the present disclosure propose a structural equation model for mixed data types, the model allowing the causal mechanism to be non-linear and thus supporting a wider range of practical applications. According to implementations of the present disclosure, the causal structure may be identified from a data distribution that follows the model, and the identified causal structure may be displayed through a directed acyclic graph. Based on the model of the present disclosure, a maximum likelihood estimator is further proposed, the maximum likelihood estimator being used to select the causal sequence between variables rather than the causal structure, and results of the maximum likelihood estimator having sequential consistency. The reason for such an approach is that the sequential space is much smaller than the directed acyclic graph space and is easy to search; moreover, if the sequence between variables is known, the causal structure learning may be attributed to variable selection. This may be solved by sparse regression or (conditional) independence test, so that the causal structure learning may be performed with less computational overhead. Therefore, the present disclosure further proposes an efficient sequential search method that benefits from a novel sequential space cutting method. With a maximum likelihood estimator, the method constructs a factor optimization problem, in which the causal sequence may be recovered using greedy search. To further accelerate sequential search, in the present disclosure a graph lasso equipped with a kernel alignment method is first used to learn the sparse skeleton between variables, and the skeleton is projected into a series of topological ordering constraints to reduce the search space. With the method, the causality among variables may be accurately determined.

In the information processing process 300, as the observed data 110 is input, an initial modeling stage 310 arrives. According to exemplary implementations of the present disclosure, in the initial modeling stage 310, a mixed non-linear causal model will be built, the model describing a non-linear relationship between mixed discrete variables and continuous variables, and the identifiability of the model being proved with further content.

While building the model, for the observed data 100, x=(X₁, . . . , X_{D}) is a mixture of continuous variables and binary variables, with no hidden variables. According to implementations of the present disclosure, categorical variables with T classes are converted into (T−1) binary variables. The distribution of X is the Markov with respect to the potential causal directed acyclic graph [symbol] =(V,ε) the directed acyclic graph comprising nodes V:={1, . . . , D} and edges ε⊆V². Each random variable Xᵢ corresponds to the i-th node in [symbol] , and if Xᵢ is the direct cause of Xⱼ, then (i,j)∈ε. According to implementations of the present disclosure, the parent set of the i-th node is represented as PAᵢ, and all non-descendants of the i-th node are represented as NDᵢ. Lowercase letters xᵢ are used to represent the observation of the random variable Xᵢ. According to one implementation of the present disclosure, the observed data is generated in the following way: the value of each continuous variable Xᵢ is used as its parent function in [symbol] plus independent additive noise ϵᵢ, and each binary variable Xi follows the Bernoulli distribution, which is characterized by a function of its parent plus an independent additive noise function ϵᵢ.

The mixed non-linear causal model may be defined through Equation (1): define the mixed non-linear causal model as a tuple tuple(S,p(ϵ)) on observed data X, wherein S=(S₁, . . . , S_{D}) is a setof D equations.

$${S}_{i} \text{:} {X}_{i} = \{ \begin{matrix}{f}_{i} ( {X}_{{PA}_{i}} ) + {ϵ}_{i} , & if {x}_{i} is continuous , \\ \{ \begin{matrix}1 , & {f}_{i} ( {X}_{{PA}_{i}} ) + {ϵ}_{i} > 0 \\ 0 , & otherwise\end{matrix} & if {x}_{i} is binary\end{matrix} \qquad ( 1 )$$

wherein Si is the i-th equation among D equations.

And p(ϵ)=p(ϵ₁, . . . , ϵ_{D})=Πᵢ₌₁^{D}p(ϵᵢ) is the joint distribution of noise variables. fᵢ is a cubic differentiable non-linear function (might be different for each i), and [symbol] fᵢ(X_{PA}_{ᵢ})|=0(i=1, . . . , D) conforms to the Gaussian distribution, and more specifically, ϵᵢ˜ [symbol] (0,σᵢ²), σᵢ>0(i=1, . . . , D). The corresponding causal graph is acyclic.

According to one implementation of the present disclosure, random variables (X₁, . . . , X_{D}) are observed for N times, and then according to the definition of the mixed non-linear causal model, the joint distribution is as below:

$$p ( {X}_{1} , … , {X}_{D} ) = \\ {\prod }_{i = 1}^{D} {{p}_{h} ( {X}_{1} \vert {X}_{{PA}_{i}} )}^{{x}_{1}} {{p}_{c} ( {X}_{1} \vert {X}_{{PA}_{i}} )}^{( 1 {x}_{i} )} - \\ {\prod }_{i = 1}^{D} {{\prod }^{N}}_{n = 1} {Φ ( \frac{{f}_{i} ( {x}_{{PA}_{i} n} )}{{σ}_{i}} )}^{{x}_{in} {x}_{i}} {( 1 - \\ Φ ( \frac{{f}_{i} ( {x}_{{PA}_{i} n} )}{{σ}_{i}} ) )}^{( 1 - {x}_{in} ) {x}_{i}} {( \frac{1}{{σ}_{i}} φ ( \frac{{x}_{in} - {f}_{i} ( {x}_{{PA}_{i} n} )}{{σ}_{i}} ) )}^{( t - {x}_{i} )} \qquad ( 2 )$$

wherein p_{b}(⋅) and p_{c}(⋅) represent the probability distribution of binary variables and continuous variables respectively. c,∈{0,1} is an indicator variable; if the variable Xi is binary, then zᵢ=1, otherwise zᵢ=0. xᵢₙ is the n-th observed value of Xᵢ, and x_{PA}_{ᵢ}ₙ is the n-th observed value of X_{PA}_{ᵢ}. φ(⋅) is the density of the standard normal distribution, and Φ(⋅) is an accumulated standard normal distribution function.

When proving the identifiability of the above built model, the following assumptions are first considered, and then the identifiability of the mixed nonlinear causal model is proved under these assumptions.

After the initial modeling stage 310, the flow proceeds to a causal sequence determining stage 320.

According to implementations of the present disclosure, a real causal structure may be identified from the joint distribution that follows the mixed non-linear causal model. However, searching the entire space of directed acyclic graphs to find the best causal graph is still time-consuming work. The structural learning problem with directed acyclic graph constraints may be converted into the problem of learning the best sequence between variables, which seems easier because the sequential space is much smaller than the directed acyclic graph space. Once the sequence is determined, acyclic constraints may be enforced by constraining the parent of a variable to be a subset of a variable before the variable. Causal structure learning may be attributed to variable selection, which may be solved by sparse regression or (conditional) independence test.

According to exemplary implementations of the present disclosure, the real causal sequence may be identified from the joint distribution that follows the mixed non-linear causal model, and then the fitting of the sequence of mixed binary variables and continuous variables may be evaluated by the Mixed Nonlinear Information Criterion (MNIC), wherein MNIC scores are sequentially consistent.

According to exemplary implementations of the present disclosure, the MNIC estimator is based on the negative log likelihood of observed values,

$$MNIC ( X , {𝒢}_{ξ} ) = {\sum }_{i = 1}^{D} ℒ ( i \vert {PA}_{i} ) = {\sum }_{i = 1}^{D} {\sum }_{n = 1}^{N} ( - {x}_{in} {x}_{i} log ( Φ ( \frac{{f}_{i} ( {x}_{{PA}_{i} n} )}{{σ}_{i}} ) ) - ( 1 - {x}_{in} ) {x}_{i} log ( 1 - Φ ( \frac{{f}_{i} ( {x}_{{PA}_{i} n} )}{{σ}_{i}} ) ) ) + {\sum }_{i = 1}^{D} \frac{( 1 - {x}_{i} ) N}{2} ( log \frac{{\sum }_{n = 1}^{N} {( {x}_{in} - {f}_{i} ( {x}_{{PA}_{i} n} ) )}^{2}}{N} + log ( 2 π e ) ) , \qquad ( 3 )$$

wherein [symbol] (i|PAᵢ):=log p(Xᵢ|X_{PA}_{ᵢ}), and l is an Euler number.

For the sake of description, a latent variable Uᵢ is introduced for each Xᵢ to represent its parent function plus independent additive noise, i.e., Uᵢ=fᵢ(X_{PA}_{ᵢ})−ϵᵢ. Then, for the continuous variable Xᵢ=Uᵢ, and for the binary variable

$${X}_{i} = \{ \begin{matrix}1 , & {U}_{i} > 0 \\ 0 , & otherwise\end{matrix} .$$

\dot{ε} represents the minimum replacement of the MNIC score in Equation (3), that is,

$$\dot{ξ} = {arg min}_{ξ} MNIC ( X , {𝒢}_{ξ} ) \qquad ( 4 )$$

Therefore, the operation in the causal sequence determining stage 320 may be performed based on the MNIC estimator, so that possible causal sequences between variables may be determined for model inputs comprising different types of variables.

According to exemplary implementations of the present disclosure, an additional sequence determining method 330 may be applied to the causal sequence determining stage 320 to achieve the effect of accelerating causality inference, the additional sequence determining method 330 comprising spatial clipping based on variable group sequence constraints. The additional sequence determining method 330 may comprise input causal information 340. The causal information 340 corresponds to the causal information discussed with reference to FIG. 2 and thus is not detailed here.

After the causal sequence determining stage 320, the flow proceeds to a causal structure learning stage 350, and then the causality 130 may be generated as output.

According to exemplary implementations of the present disclosure, a three-stage algorithm may be used to estimate the causal structure of observed data, i.e., to perform the operations in the causal sequence determining stage 320 and the causal structure learning stage 350. First, a graph lasso equipped with a kernel alignment method is used to learn the sparse skeleton between variables, and then the skeleton is projected to a series of topological ordering constraints so as to reduce the search space. Next, under sequence constraints, greedy search is used in feasible space to estimate \dot{ε} in Equation (4). Finally, a kernel-based conditional independence (KCI) test is used to trim edges so as to recover [symbol] _{\dot{ε}}^{full,min} from [symbol] _{\dot{ε}}^{full}. The whole algorithm is briefed in Algorithm 1.

Algorithm 1 MNIC-Based Causal Structure Learning

Algorithm input: data X, the number D of variables, the maximum size mCS of conditional set, a threshold Cv,

Algorithm output: optimum structure [symbol] ∈{0,1}^{D} [symbol] ^{D}, causal sequence \hat{ε},

Stage 1: Generate Topological Ordering Constraints

Use Equations (9) and (10) to build a precision matrix Θ

Extract M SCC from Θ

Assign a random group sequence, e.g., SCC₁ [symbol] . . . [symbol] SCC_{M}, and build a sequential constraint set C

Stage 2: Estimate the Causal Sequence (Corresponding to the Causal Sequence Determining Stage 320)

Initialize the empty directed acyclic graph [symbol] =0, the score matrix s={−inf}^{O×D}, and t=1

```
Calculate S^{t}[i, j] = [symbol] (j|i) − [symbol]  (j|θ) if Θ_{i,j} ≠ 0
if i [symbol]  j violates C then S^{t}[i, j] = −inf.
for m = 1, . . . , M do
  while TRUE do
    Find (î, j) = argmax_{i,j∈SCC}_{ₘ} S^{t}[i, j].
    if S^{t}[i, ĵ] = −inf then break.
    Set [symbol] [î, j] = 1, and add î [symbol]  ĵ^to \hat{ξ}\hat{.}
    Set S^{t}[i, j] = −inf, ∀i, j ∈ SCCₘ that violate acycle.
    i = t + 1
    Update S^{t}[i, ĵ] = [symbol]  (j|PAⱼ, i) − [symbol]  (ĵ|PAⱼ) −S^{t-1} [i, ĵ] if S^{t-1} [i, ĵ] ≠ −inf, ∀i ∈ SCCₘ.
  end while
end for
```

Stage 3: Remove Extra Edges (Corresponding to the Causal Structure Learning Stage 350)

```
for CS = {0, . . . , mCS} do
  for j = {\hat{ξ}(CS + 2), . . . , \hat{ξ}(D)} do
    PAⱼ = {i | [symbol] |i, j| = 1}
    for i ∈ PAⱼ do
      K = (PAⱼ\i) ∪ PA,
      if |K| ≥ CS then
        for every k ⊆ K with |k| = CS · p = KCI (Xᵢ, Xⱼ|Xₖ), if p > α, then [symbol]  [i, j] = 0, break.
      end if
    end for
  end for
end for
```

According to exemplary implementations of the present disclosure, in Algorithm 1, when building the precision matrix Θ, other methods may further be used, such as feature selecting methods that include random forest, HSIC lasso and so on. Meanwhile, the precision matrix may also be built by introducing expert knowledge.

According to exemplary implementations of the present disclosure, in stage 3 of Algorithm 1, not only a method based on independence judgment may be used to remove edges, but also a feature selecting method may be used.

According to exemplary implementations of the present disclosure, the causal sequence determining stage 320 may comprise search spatial cutting: kernel alignment may be used to measure the similarity between two kernel functions, and also may be used to generate a pseudo-correlation matrix between random variables. According to implementations of the present disclosure, Equation (9) is used to generate the pseudo-correlation matrix A on the observed data X=(X₁, . . . , X_{D}), wherein each element A(i,j) is kernel alignment between Xᵢ and Xⱼ.

$$A ( i , j ) = \frac{< {K}_{i} , {K}_{j} >}{\sqrt{< {K}_{i} , {K}_{i} > < {K}_{j} , {K}_{j} >}} \qquad ( 9 )$$

Wherein <Kᵢ,Kⱼ>=Σ_{n,n′wi}^{N}Kᵢ(n,n′)Kⱼ(n,n′), and Kᵢ(n,n′) is the (n,n′)-th element of the central kernel matrix of Xᵢ. Here, the RBF kernel is used for continuous variables, and the delta kernel is used for binary variables. Then, A is introduced to the graph lasso so as to learn the precision matrix Θ:

$$Θ = arg {min}_{Θ ≻ 0} tr ( A Θ ) - log det ( Θ ) + λ {\sum }_{i , j} \vert {Θ}_{ij} \vert \qquad ( 10 )$$

Wherein Θᵢⱼ=0 represents that there is no direct edge between Xᵢ and Xⱼ.

Strong connection components (SCC) are generated from Θ; since no edge connects different SCCs, topological sequences between SCCs may be assigned at random. If SCCₘ [symbol] SCCₘ′ is assigned, then for all Xᵢ∈SCCₘ and Xⱼ∈SCCₘ′, Xᵢ [symbol] Xⱼ. These sequential constraints will be used to reduce the search space in the second stage.

According to exemplary implementations of the present disclosure, the causal sequence determining stage 320 may further comprise sequential search: using a greedy search program similar to CAM. Starting with an empty directed acyclic graph, an edge i→j corresponding to the steepest decline of MNIC is added at each iteration. Acyclicity is checked after each iteration, and a super directed acyclic graph is constructed after all iterations. \dot{f},(⋅) is estimated using Gaussian process regression (classification), and a super parameter is learned by maximizing marginal likelihood. The time complexity of the sequential search algorithm is O(M maxₘ|SCCₘ|N³), wherein M is the number of SCCs, |SCCₘ| the number of edges in SCCₘ according to Θ, wherein m∈{1, . . . , M}, and N is the number of samples.

According to exemplary implementations of the present disclosure, the causal structure learning stage 350 may comprise trimming: using a conditional independence test to trim pseudo-edges from the super directed acyclic graph. In the conditional independence test, there exist some hyper-parameters: the kernel width and regularization parameters used to construct the kernel matrix. For an unconditional independence test, since the continuous variable has been regularized to unit variance, the median of the paired distances of these points is used as the kernel width. For a conditional independence test, when the conditional set is small (i.e., ≤2), the median of the paired distances of these points is used as the kernel width. For the regularization parameter, an empirical value (10⁻³) is used, which shows good effect. When the conditional set is large, the extended multi-output Gaussian process regression is used to learn hyper-parameters by maximizing the total marginal likelihood.

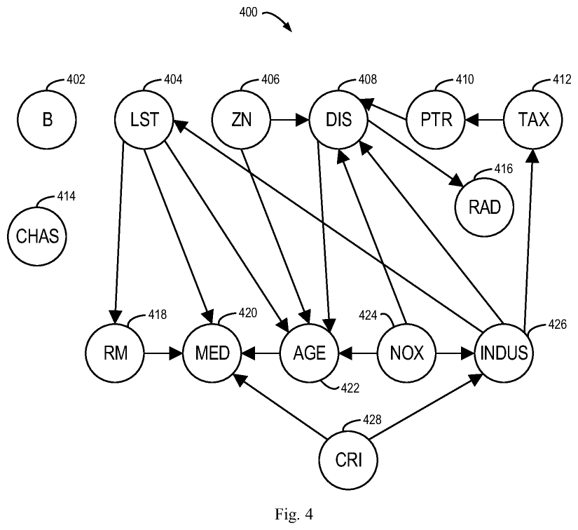

According to exemplary implementations of the present disclosure, as described above, the causality may take the form of a directed acyclic graph. Further with reference to FIG. 4, this figure shows a schematic view of a causality graph 400 according to exemplary implementations of the present disclosure.

The causality graph 400 comprises 14 variables, namely the proportion of black people (B) 402, the percentage of low population status (LST) 404, the proportion of residential land (ZN) 406, the weighted distance to the job center (DIS) 408, pupil-teacher ratio (PTR) 410, full-value property tax rate (TAX) 412, located on the Charles River (CHAS) 414, radial road accessibility index (RAD) 416, average number of rooms (RM) 418, median housing (MED) 420, percentage built before 1940 (AGE) 422, nitric oxide concentration (NOX) 424, proportion of non-retail business (INDUS) 426 and crime rate (CRI) 428, wherein located on the Charles River 414 is a discrete variable. The causality graph 400 specifically indicates a causal graph generated from the Boston housing dataset, which is a causality graph determined using more than 500 samples by the information processing method 200 according to exemplary implementations of the present disclosure.

The causality graph 400 shows that the average number of rooms (RM), the percentage of low population status (LST), the percentage built before 1940 (AGE) and the crime rate (CRI) are direct causes of the median home value (MED). Besides, the causality graph 400 further reflects, for example, the link from the tax rate (TAX) to the pupil-teacher rate (PTR), and from the distance to job center (DIS) to the radial road accessibility index (RAD).

Apparently, in terms of causal structure discovery and sequence recovery, the information processing method 200 according to exemplary implementations of the present disclosure may bring about good results, especially in the case of dense graphs and high mixed data ratios.

With reference to FIGS. 1 to 4, description has been presented above to contents of the information processing environment 100, the information processing method 200, the information processing process 300 and the causality graph 400 according to exemplary implementations of the present disclosure. It should be understood the above description is provided for better demonstrating contents of the present disclosure, rather than limiting in any way.

It should be understood that the number of various elements and the size of the physical quantities in the above figures of the present disclosure are only exemplary, and are not intended to limit the protection scope of the present disclosure. The above number and size may be set at random according to needs, without any impact on the normal implementation of the present disclosure.

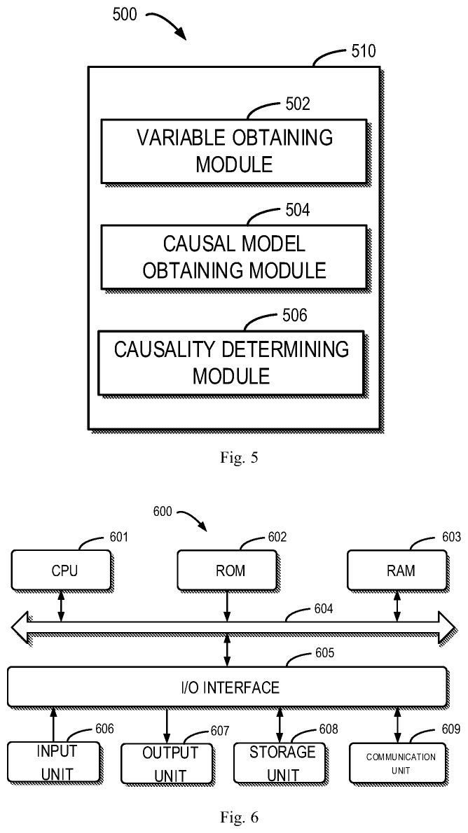

Details about the information processing method according to implementations of the present disclosure have been described with reference to FIGS. 1 to 4. Now various modules in the information processing apparatus will be described with reference to FIG. 5.

FIG. 5 shows a block diagram of an information processing apparatus 500 according to exemplary implementations of the present disclosure. As depicted, the information processing apparatus 500 is provided, comprising: a variable obtaining module 502 configured to obtain a group of variables; a causal model obtaining module 504 configured to obtain a causal model; and a causality determining module 506 configured to use the causal model to determine causality among variables in the group of variables based on types of variables in the group of variables. According to some exemplary implementations of the present disclosure, the information processing apparatus 500 is configured to perform specific steps of the information processing method 200 shown in FIG. 2.

In some implementations, the type of variables in the group of variables comprises at least one of continuous variable type and discrete variable type.

In some implementations, the causality determining module 506 comprises: a set of parent variables determining module (not shown) configured to, for each variable in the group of variables, determine a set of parent variables of the variable, the set of parent variables being a set of variables on which a value of the variable relies; and a first causality determining module (not shown) configured to determine the causality based on the types and the set of parent variables.

In some implementations, the causality determining module 506 comprises: a causal sequence determining module (not shown) configured to determine a causal sequence among the variables in the group of variables; and a second causality determining module (not shown) configured to determine the causality based on the causal sequence.

In some implementations, the causal sequence determining module comprises: an initial causal sequence determining module (not shown) configured to determine an initial causal sequence among the variables in the group of variables; a fitness determining module (not shown) configured to determine fitness of the initial causal sequence, the fitness indicating a probability that the initial causal sequence correctly represents the causal sequence among the variables; and a first causal sequence determining module (not shown) configured to determine the causal sequence based on the fitness and the initial causal sequence.

In some implementations, the causal sequence determining module comprises: a set of parent variables determining module (not shown) configured to, for each variable in the group of variables, determine a set of parent variables of the variable, the set of parent variables being a set of variables on which a value of the variable relies; a parent relationship graph generating module (not shown) configured to generate a parent relationship graph of each variable in the group of variables based on the set of parent variables; and a second causal sequence determining module (not shown) configured to determine the causal sequence based on the parent relationship graphs.

In some implementations, the causality determining module 506 comprises: an association determining module (not shown) configured to determine association among the variables in the group of variables based on the types; and a third causality determining module (not shown) configured to determine the causality based on the causal sequence and the association.

In some implementations, the causality determining module 506 comprises: an initial causality determining module (not shown) configured to determine initial causality among variables in the group of variables based on the causal sequence; a conditional independence test module (not shown) configured to perform a conditional independence test on the initial causality; and a fourth causality determining module (not shown) configured to determine the causality based on a result of the conditional independence test and the initial causality.

In some implementations, the initial causality determining module comprises: an association determining module (not shown) configured to determine association among the variables in the group of variables based on the types; and a first initial causality determining module (not shown) configured to determine initial causality among variables in the group of variables based on the causal sequence and the association.

In some implementations, the causality determining module 506 comprises: a causal information obtaining module (not shown) configured to obtain causal information about the group of variables, the causal information indicating partial causality among a part of variables in the group of variables; and a fifth causality determining module (not shown) configured to determine the causality among variables in the group of variables based on the causal sequence and the causal information.

In some implementations, the fifth causality determining module comprises: an association determining module (not shown) configured to determine association among the variables in the group of variables based on the types; and a sixth causality determining module (not shown) configured to determine the causality among variables in the group of variables based on the causal sequence, the association, and the causal information.

In some implementations, the causality determining module 506 comprises: a seventh causality determining module (not shown) configured to determine the causality through at least one of: a constraint-based solution and a search-based solution.

In some implementations, the causality takes the form of a directed acyclic graph, the directed acyclic graph comprising nodes and edges, the nodes representing variables in the group of variables, the edges representing causality among the variables.

In some implementations, the group of variables is associated with an application system and represent multiple attributes of the application system.

In some implementations, the information processing apparatus 500 further comprises at least one of: a performance improving module (not shown) configured to improve performance of the application system based on the causality; and a troubleshooting module (not shown) configured to debug the application system based on the causality.

As seen from the above description with reference to FIGS. 1 to 5, the technical solution according to implementations of the present disclosure has many advantages over traditional solutions. For example, with the present technical solution, a mixture of complex, non-linear continuous data or discrete data may be processed using a new model, and causality among these observed data may be determined. The technical solution not only can process complex mixed observed data but also can determine causality efficiently and effectively. Thus, the technical solution may be applied to pharmaceutical, manufacturing, market analysis and other application systems, so as to improve performance of these application systems and debug them.

FIG. 6 shows a schematic block diagram of an example device 600 suitable for implementing implementations of the present disclosure. For example, the computing device as shown in FIG. 1 may be implemented by the device 600. As depicted, the device 600 comprises a central processing unit (CPU) 601 which is capable of performing various appropriate actions and processes in accordance with computer program instructions stored in a read only memory (ROM) 602 or computer program instructions loaded from a storage unit 608 to a random access memory (RAM) 603. In the RAM 603, there are also stored various programs and data required by the device 600 when operating. The CPU 601, the ROM 602 and the RAM 603 are connected to one another via a bus 604. An input/output (I/O) interface 605 is also connected to the bus 604.

Multiple components in the device 600 are connected to the I/O interface 605: an input unit 606 including a keyboard, a mouse, or the like; an output unit 607, such as various types of displays, a loudspeaker or the like; a storage unit 608, such as a disk, an optical disk or the like; and a communication unit 609, such as a LAN card, a modem, a wireless communication transceiver or the like. The communication unit 609 allows the device 600 to exchange information/data with other device via a computer network, such as the Internet, and/or various telecommunication networks.

The above-described procedures and processes, e.g., the method 200, may be executed by the processing unit 601. For example, in some implementations, the method 200 may be implemented as a computer software program, which is tangibly embodied on a machine readable medium, e.g. the storage unit 608. In some implementations, part or the entirety of the computer program may be loaded to and/or installed on the device 600 via the ROM 602 and/or the communication unit 609. The computer program, when loaded to the RAM 603 and executed by the CPU 601, may execute one or more acts of the method 200 as described above.

According to exemplary implementations of the present disclosure, an information processing device is provided, comprising: at least one processing unit; at least one memory, coupled to the at least one processing unit and storing instructions to be executed by the at least one processing unit, the instructions, when executed by the at least one processing unit, causing the device to perform the method 200 described above.

The present disclosure may be a method, an apparatus, a system, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various implementations of the present disclosure have been presented for purposes of illustration, but are not intended to be exhaustive or limited to implementations disclosed. Many modifications and variations will be apparent to those of ordinary skill in the art without departing from the scope and spirit of the described implementations. The terminology used herein was chosen to best explain the principles of implementations, the practical application or technical improvement over technologies found in the marketplace, or to enable others of ordinary skill in the art to understand implementations disclosed herein.

1. An information processing method, comprising:
obtaining a group of variables;
obtaining a causal model; and
using the causal model to determine causality among variables in the group of variables based on types of the variables in the group of variables.

2. The method according to claim 1, wherein the types comprise at least one of a continuous variable type and a discrete variable type.

3. The method according to claim 1, wherein determining the causality comprises:
for each variable in the group of variables, determining a set of parent variables of the variable, the set of parent variables being a set of variables on which a value of the variable relies; and
determining the causality based on the types and the set of parent variables.

4. The method according to claim 1, wherein determining the causality comprises:
determining a causal sequence among the variables in the group of variables; and
determining the causality based on the causal sequence.

5. The method according to claim 4, wherein determining the causal sequence comprises:
determining an initial causal sequence among the variables in the group of variables;
determining fitness of the initial causal sequence, the fitness indicating a probability that the initial causal sequence correctly represents the causal sequence among the variables; and
determining the causal sequence based on the fitness and the initial causal sequence.

6. The method according to claim 4, wherein determining the causal sequence comprises:
for each variable in the group of variables, determining a set of parent variables of the variable, the set of parent variables being a set of variables on which a value of the variable relies;
generating a parent relationship graph of each variable in the group of variables based on the set of parent variables; and
determining the causal sequence based on the parent relationship graphs.

7. The method according to claim 4, wherein determining the causality comprises:
determining association among the variables in the group of variables based on the types; and
determining the causality based on the causal sequence and the association.

8. The method according to claim 4, wherein determining the causality comprises:
determining initial causality among variables in the group of variables based on the causal sequence;
performing a conditional independence test on the initial causality; and
determining the causality based on a result of the conditional independence test and the initial causality.

9. The method according to claim 8, wherein determining the initial causality comprises:
determining association among the variables in the group of variables based on the types; and
determining initial causality among variables in the group of variables based on the causal sequence and the association.

10. The method according to claim 4, wherein determining the causality comprises:
obtaining causal information about the group of variables, the causal information indicating partial causality among a part of variables in the group of variables; and
determining the causality among variables in the group of variables based on the causal sequence and the causal information.

11. The method according to claim 10, wherein determining the causality comprises:
determining association among the variables in the group of variables based on the types; and
determining the causality among variables in the group of variables based on the causal sequence, the association, and the causal information.

12. The method according to claim 1, wherein determining the causality comprises determining the causality through at least one of: a constraint-based solution and a search-based solution.

13. The method according to claim 1, wherein the causality takes the form of a directed acyclic graph, the directed acyclic graph comprising nodes and edges, the nodes representing variables in the group of variables, the edges representing causality among the variables.

14. The method according to claim 1, wherein the group of variables is associated with an application system and represent multiple attributes of the application system.

15. The method according to claim 14, further comprising at least one of:
improving performance of the application system based on the causality; and
debugging the application system based on the causality.

16. An information processing device, comprising:
at least one processing unit; and
at least one memory, coupled to the at least one processing unit and storing instructions executed by the at least one processing unit, the instructions, when executed by the at least one processing unit, causing the device to perform acts, including:
obtaining a group of variables;
obtaining a causal model; and
using the causal model to determine causality among variables in the group of variables based on types of the variables in the group of variables.

17. The device according to claim 16, wherein the types comprise at least one of continuous variable type and discrete variable type.

18. The device according to claim 16, wherein determining the causality comprises:
for each variable in the group of variables, determining a set of parent variables of the variable, the set of parent variables being a set of variables on which a value of the variable relies; and
determining the causality based on the types and the set of parent variables.

19. The device according to claim 16, wherein determining the causality comprises:
determining a causal sequence among the variables in the group of variables; and
determining the causality based on the causal sequence.

20.-30. (canceled)

31. A computer-readable storage medium, having computer-readable program instructions stored thereon, the computer-readable program, when executed by a processor, cause the processor to perform acts, the acts comprising:
obtaining a group of variables;
obtaining a causal model; and
using the causal model to determine causality among variables in the group of variables based on types of the variables in the group of variables.
